(19) United States
(12) Patent Application Publication
(10) Pub. No.: US 2014/0010520 A1
(43) Pub. Date: Jan. 9, 2014

(54) DYNAMIC MANAGEMENT OF SLIDE PRESENTATIONS

(71) Applicants: Nimesh Bhatia, San Jose, CA (US); Gregory J. Boss, Saginaw, MI (US); Srinivas Chidurala, Andhrapradesh (IN); Jose I. Vargas, Hollister, CA (US)

(72) Inventors: Nimesh Bhatia, San Jose, CA (US); Gregory J. Boss, Saginaw, MI (US); Srinivas Chidurala, Andhrapradesh (IN); Jose I. Vargas, Hollister, CA (US)

(73) Assignee: International Business Machines Corporation, Armonk, NY (US)

(21) Appl. No.: 13/540,787

(22) Filed: Jul. 3, 2012

(51) Int. Cl. H04N 5/93

(52) U.S. Cl. 386/278; 386/E05.003

(57) ABSTRACT

Embodiments of the present invention provide a system, method, and computer program product for dynamically managing a slide presentation. On the basis of subject matter tags, audience tags, priority information, and other metadata associated with each slide in a slide presentation, the slide presentation can be automatically adjusted during creation and presentation of the slide presentation such that a target presentation time can be achieved. Elapsed presentation times can be displayed to a presenter and audience, along with an indication of whether the presentation is on schedule, or is running ahead of or behind schedule.

### FIELD OF THE INVENTION

The present invention relates generally to electronic presentations and, more particularly, to dynamic management of electronic slide presentations.

### BACKGROUND

Electronic presentations, particularly electronic slide presentations (hereinafter, “slide presentations”), have become key tools for conveying information to an audience during a speech or other presentation. In a typical slide presentation, a presenter utilizes software to create and arrange multiple slides and then present the slides to an audience, beginning with the first slide and ending with the last slide.

Often, a time constraint is imposed on the presenter, and staying on schedule is important as both the presenter and the audience may have a limited amount of time to devote to the presentation. For example, the presenter may be allotted a particular time slot during a conference or meeting in which to deliver his or her presentation. Maintaining an appropriate pace, however, can be difficult for the presenter on account of varying factors both within and beyond his or her control. For example, certain slides may contain detailed information that takes longer to present, audience members may ask questions or request that the presenter spend more time explaining some slides, or the audience may request that the presenter discuss different material altogether.

In addition to these factors, maintaining an appropriate pace and making necessary adjustments can be difficult for the presenter because he or she must focus on delivering the presentation, while also keeping track of time, the material that has been discussed, and the material which remains to be discussed.

### SUMMARY

Embodiments of the present invention provide a system, method, and computer program product for dynamically managing a slide presentation. A computer system identifies a plurality of slides in a slide presentation. Each slide is associated with metadata, including a subject matter tag and a slide duration within which presentation of the slide should be completed. The computer system receives a presentation duration within which the slide presentation should be completed. The computer system determines whether the slide presentation can be completed within the presentation duration. If the computer system determines that the slide presentation can not be completed within the presentation duration, the computer system adjusts the slide presentation based, at least in part, on the metadata associated with each slide, such that the slide presentation can be completed within the presentation duration. The computer system then reorders one or more slides in the slide presentation based, at least in part, on the metadata associated with each slide. Adjusting the slide presentation can involve reducing the slide duration of one or more slides and hiding one or more slides such that the hidden one or more slides are not presented.

### BRIEF DESCRIPTION OF THE SEVERAL VIEWS OF THE DRAWINGS

FIG. 1 is a block diagram of a presentation system in accordance with an embodiment of the present invention.

FIG. 2 is a flowchart illustrating operational steps for creating a slide in accordance with an embodiment of the present invention.

FIG. 3 is a flowchart illustrating operational steps for creating a slide presentation in accordance with an embodiment of the present invention.

FIG. 4 is a flowchart illustrating operational steps for reducing the presentation time of one or more slides in a presentation and/or hiding one or more slides in a slide presentation in accordance with an embodiment of the present invention.

FIG. 5 is a flowchart illustrating operational steps for reordering slides in a slide presentation in accordance with an embodiment of the present invention.

FIG. 6 is a flowchart illustrating operational steps for indicating an elapsed presentation time for a slide.

FIG. 7 is a flowchart illustrating operational steps for indicating an elapsed presentation time for a presentation.

FIG. 8 is a flowchart illustrating operational steps for reducing the presentation time of one or more slides in a presentation and/or hiding one or more slides in a slide presentation in accordance with an embodiment of the present invention.

FIG. 9 is a block diagram of internal and external components of the computer system of FIG. 1 in accordance with an embodiment of the present invention.

### DETAILED DESCRIPTION

Briefly, a preferred embodiment of the present invention is practiced in the context of preparing and presenting a slide presentation using graphical slide presentation software. A user can create slides and associate each slide with information such as target presentation times (i.e., durations of time) for the slide, subject matter tags, audience tags, and priority information. After creating the slides, the user can create a slide deck (i.e., an arrangement of slides) for a particular presentation. The user can specify an audience and total target presentation time for the presentation, and choose which slides to include in the slide deck. Based on the information associated with each of the slides included in the slide deck, if necessary, the slide deck can be automatically adjusted pursuant to specified criteria (e.g., slides can be shortened, hidden, and/or reordered) to fit the specified total target time for the presentation.

When presenting the slide presentation, the elapsed presentation times for each slide and the overall presentation are monitored and displayed, including indications of how the elapsed times compare to specified target times to enable the user and others to discern whether the presentation is on schedule, or is running ahead of or behind schedule. Based on the elapsed times and the information associated with each of the slides included in the slide deck, if necessary, the remaining portion of the slide deck that has not yet been presented can be automatically adjusted pursuant to specified criteria to fit the specified total target time for the presentation.

Embodiments of the present invention will now be described in detail with reference to the accompanying drawings.

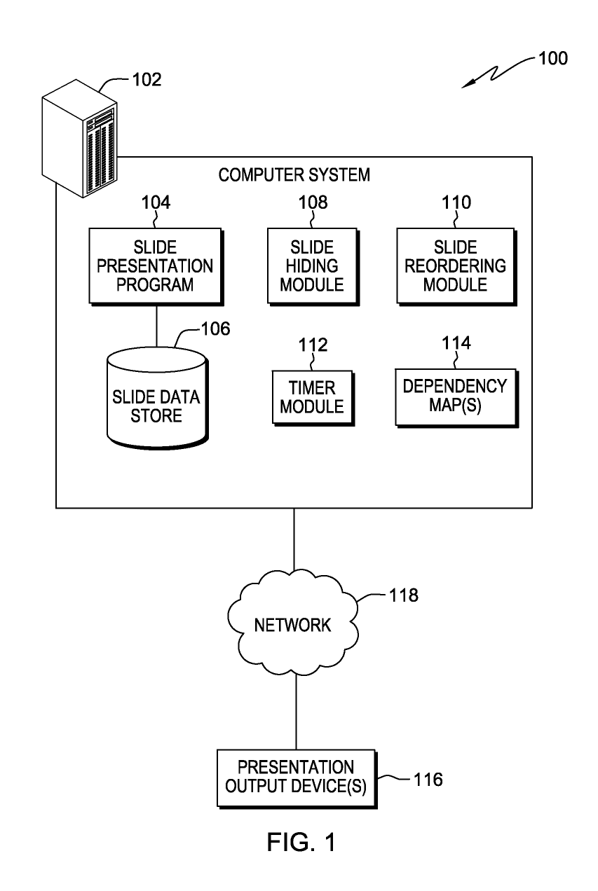

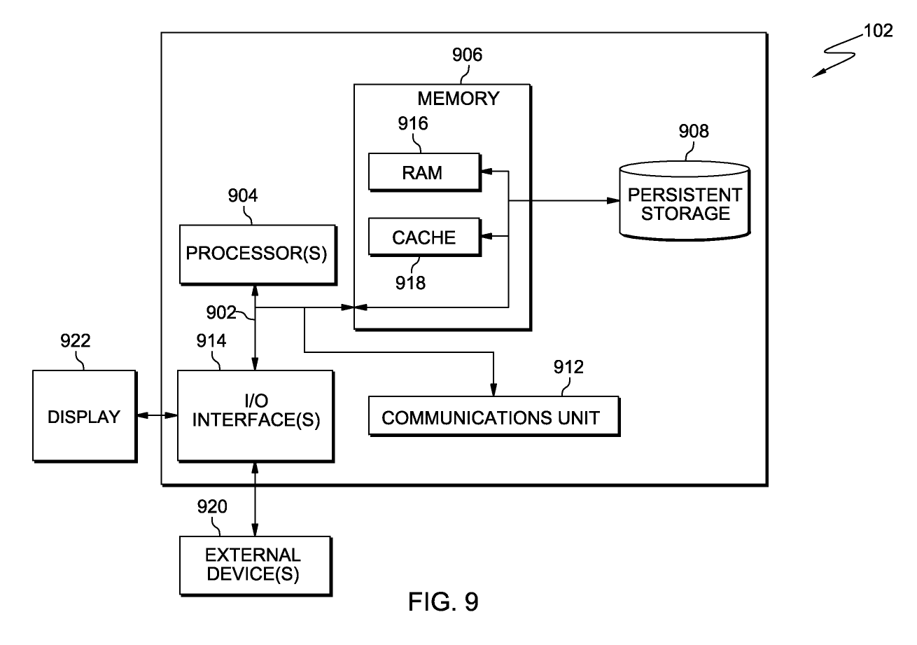

FIG. 1 is a functional block diagram of a presentation system 100 in accordance with an embodiment of the present invention. Presentation system 100 includes computer system 102 and one or more presentation output devices 116 interconnected by network 118. Computer system 102 can be a desktop computer, laptop computer, specialized computer server, or any other computer system known in the art. In general, computer system 102 is representative of any electronic devices or combination of electronic devices capable of executing machine-readable program instructions, as described in greater detail with regard to FIG. 9.

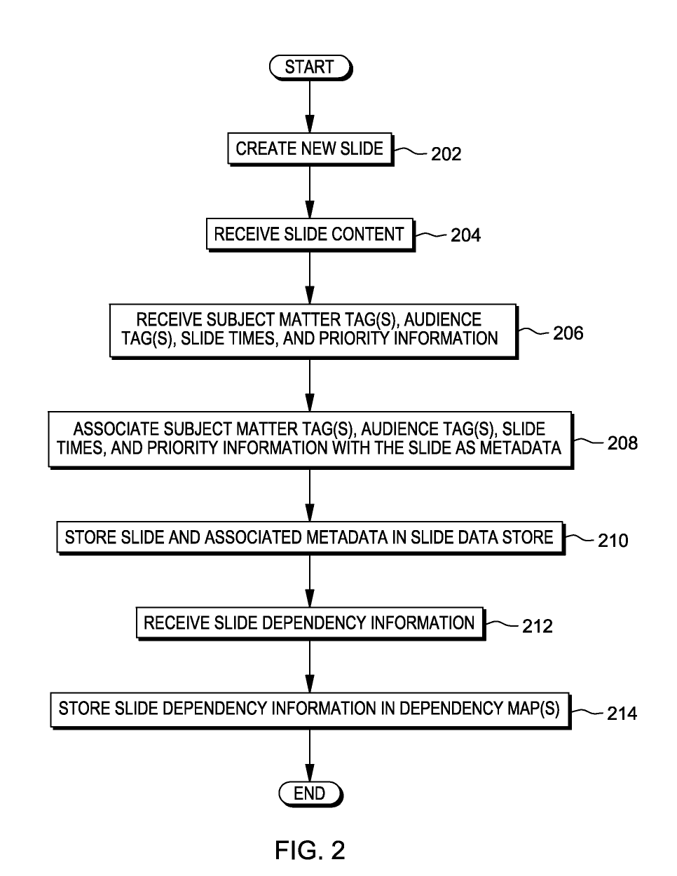

Computer system 102 includes slide presentation program 104, slide data store 106, slide hiding module 108, slide reordering module 110, timer module 112, and one or more dependency maps 114. Slide presentation program 104 is a software program with which a user (hereinafter, “presenter”) can create slides, create a slide deck, and present a slide presentation to one or more individuals (hereinafter, “audience”) in accordance with embodiments of the present invention. Slide presentation program 104 can receive from the presenter information pertaining to each slide and store that information as slide metadata. For example, slide metadata can include specified target presentation times for the slides, subject matter tags, audience tags, and priority information, as discussed in greater detail with regard to FIG. 2. When presenting a slide presentation, slide presentation program 104 can output data to one or more presentation output devices 116 via network 118 for visual and/or aural delivery of slide presentation content to the audience.

Slide data store 106 stores slides and slide metadata created with slide presentation program 104 in accordance with embodiments of the present invention. Slides and slide metadata can also be retrieved from slide data store 106. Slide data store 106 can be implemented with any database architecture known in the art.

Slide hiding module 108 operates to reduce specified target presentation times for slides and/or hide slides such that a total target presentation time can be met. Hiding a slide, as discussed in greater detail later in this specification, involves marking the slide with a “hide” designation such that it is not displayed during the slide presentation. Hidden slides remain in the slide deck and are viewable by the presenter, allowing for the possibility that the hidden slides can later be reintroduced into the slide presentation (i.e., presented during the slide presentation) by having their respective “hide” designations removed. After these operations have been performed, slide reordering module 110 operates to reorder one or more remaining slides in the slide deck.

Timer module 112 operates to monitor the elapsed presentation times for each slide and the elapsed presentation time for the entire presentation, both of which can be displayed to the presenter and/or audience. Timer module 112 can compare these elapsed times to specified target times for each slide and the total target presentation time and provide an indication to the presenter and/or audience of any discrepancies (e.g., running over or under the target times). Also, timer module 112 can initiate the reduction of specified slide presentation times, hiding of slides, and reintroduction of hidden slides into the slide presentation such that the total target presentation time can be met.

One or more dependency maps 114 store information pertaining to specified dependencies (i.e., relationships) between slides stored in slide data store 106, as discussed in greater detail with regard to FIG. 2. Slide hiding module 108 and slide reordering module 110 can access one or more dependency maps 114, and the specified dependencies can affect, for example, which slides are hidden or how slides might be reordered. One or more dependency maps 114 can be implemented with one or more tables or with any known database architecture. In other embodiments, dependency information can be stored with each slide as slide metadata.

When presenting a slide presentation, one or more presentation output devices 116 receive slide presentation data from slide presentation program 104 via network 118 and deliver the data to the audience. One or more presentation output devices 116 can deliver the slide presentation data to the audience aurally and/or visually, depending on the content of the slide presentation. One or more presentation output devices 116 can include, for example, one or more display monitors, multimedia projectors, and/or speakers.

Network 118 can be, for example, a local area network (LAN), a wide area network (WAN) such as the Internet, or a combination of the two, and include wired, wireless, or fiber optic connections. In general, network 118 can be any combination of connections and protocols that will support communications between computer system 102 and one or more presentation output devices 116 in accordance with a desired embodiment of the invention.

It should be understood that, for illustrative purposes, FIG. 1 does not show other computer systems and elements which may be present when implementing embodiments of the present invention.

FIG. 2 is a flowchart illustrating operational steps for creating a slide in accordance with an embodiment of the present invention. In this exemplary embodiment, slide presentation program 104 provides a graphical user interface with which the presenter can interact. In step 202, slide presentation program 104 creates a new slide. For example, slide presentation program 104 can generate an empty, blank slide into which the user can add content.

In step 204, slide presentation program 104 receives slide content to add to the slide. For example, the presenter can input text, create a graph, and add image files, video files, and audio files.

In step 206, slide presentation program 104 receives one or more subject matter tags, one or more audience tags, slide presentation times, and priority information. Subject matter tags are utilized to categorize the slide on the basis of the slide content. In this exemplary embodiment of the present invention, subject matter tags are specified by the presenter by inputting one or more keywords or phrases. For example, subject matter tags may indicate generally the subject matter or purpose of the slide, such as “technical architecture” or “business value,” or subject matter tags may indicate the specific subject matter of the slide, such as “project 123” and “research summary”. If the presenter does not specify and input at least one subject matter tag, slide presentation program 104 generates one or more default subject matter tags, such as “all-purpose”.

Audience tags are utilized to categorize the slide on the basis of one or more appropriate audiences for the slide. In this exemplary embodiment of the present invention, audience tags are specified by the presenter by inputting one or more keywords or phrases. For example, audience tags may indicate generally the appropriate audiences for the slide, such as “business audience” or “technical audience,” or audience tags may indicate more specifically the appropriate audiences for the slide, such as “board members”. If the presenter does not specify and input at least one audience tag, slide presentation program 104 generates one or more default audience tags, such as “all audiences”.

Slide presentation times are one or more target presentation durations for the slide. In this exemplary embodiment of the present invention, the presenter specifies and inputs a minimum slide time, an ideal slide time, and a maximum slide time. If the presenter does not specify slide presentation times, slide presentation program 104 can assign default slide presentation durations.

Priority information is utilized to categorize the slide based on its anticipated importance in a presentation. Priority information may be, for example, in numerical form or textual form. In one embodiment, the presenter can specify and input a priority value for the slide as a number within a finite range, such as 1 through 5. In another embodiment, the presenter can specify and input a priority value for the slide as “high,” “medium,” or “low”. Priority information can also include a weighted priority value. In one embodiment, a dynamic weighted value can be adjusted automatically during a slide presentation based on estimated importance, as measured by how much time was spent presenting earlier slides in the slide deck that have one or more of the same subject matter tags.

In step 208, slide presentation program 104 associates the one or more subject matter tags, audience tags, slide times, and priority information with the slide as slide metadata. In step 210, slide presentation program 104 stores the slide and its associated metadata in slide data store 106.

In step 212, slide presentation program 104 receives slide dependency information. For example, the presenter can specify that the slide should precede or be preceded by one or more other slides (i.e., order-based dependency), or that the inclusion of the slide in a slide deck requires the inclusion of one or more other slides in the slide deck (i.e., group-based dependency). Order-based dependency can be useful, for example, if the presenter wishes for the slide to serve as an introduction to a slide immediately following it. Group-based dependency can be useful, for example, if the slide may not make sense to an audience without the context that one or more other slides afford. The presenter can also specify that no dependencies are applicable.

In step 214, slide presentation program 104 stores any slide dependency information received in step 212 in one or more dependency maps 114.

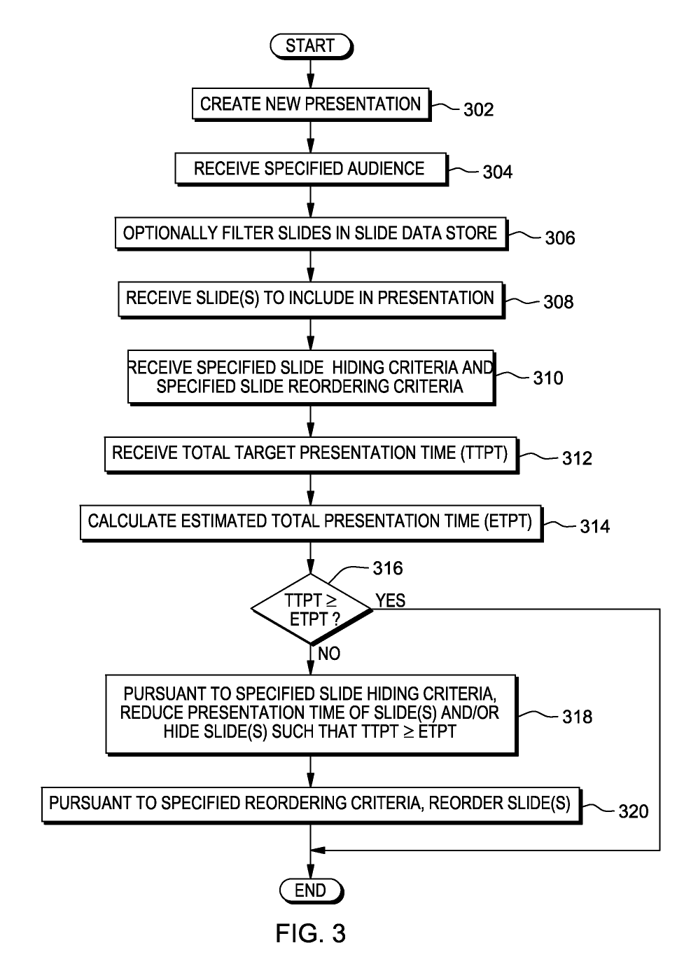

FIG. 3 is a flowchart illustrating operational steps for creating a slide presentation in accordance with an embodiment of the present invention. In this exemplary embodiment, as with the exemplary embodiment discussed with regard to FIG. 2, slide presentation program 104 provides a graphical user interface with which the presenter can interact. In this exemplary embodiment, slide data store 106 serves as a master repository from which slides can be selected for inclusion in the slide deck. For example, this embodiment can allow the presenter to include slides that had been created for past slide presentations. Similarly, this embodiment can allow the presenter to create slides when the audience demographic is not certain or when the topics the presenter is considering for presentation are in flux. Later, when the audience demographic is more certain or when the presenter is sure of the topics he or she wishes to present, the presenter can then select the appropriate slides.

In step 302, slide presentation program 104 creates a new presentation. For example, slide presentation program 104 can generate an empty, blank presentation into which the presenter can add slides that are stored in slide data store 106 (in later steps) to assemble a slide deck. Alternatively, the new presentation and slide deck can be created concurrently with the creation of slides. For example, slides can be added to the slide deck for the new presentation as they are created.

In step 304, slide presentation program 104 receives a specified audience for the presentation. In one embodiment, slide presentation program 104 accesses slide metadata stored in slide data store 106 to retrieve and display to the presenter a list of all audience tags; the presenter can specify an audience for the presentation by selecting from the list one or more appropriate audience tags. In another embodiment, the presenter can specify an audience for the presentation by inputting one or more audience tags in text form.

In step 306, slide presentation program 104 optionally filters all slides that are stored in slide data store 106 on the basis of the specified audience received in step 304. For example, if, in step 304, the presenter selected a “business audience” audience tag, then, in step 306, slide presentation program 104 can display to the presenter a list of all slides stored in slide data store 106 whose slide metadata includes the “business audience” audience tag. Slide presentation program 104 can also display to the presenter slides whose slide metadata includes a default audience tag (i.e., an audience tag indicating the slides are appropriate for all audiences). Additionally, slide presentation program 104 can further filter the slides stored in slide data store 106 on the basis of one or more subject matter tags. For example, after slide presentation program 104 displays to the presenter a list of slides based on the specified audience, the presenter can input one or more subject matter tags to further filter the list of slides.

In step 308, slide presentation program 104 receives one or more slides to include in the presentation. For example, the presenter can select one or more slides from the list of slides displayed in step 306, and then arrange those slides in an appropriate order. In embodiments where slides are added to the slide deck for the new presentation as they are created, the presenter can arrange the slides in an appropriate order, remove slides, and add other slides that are stored in slide data store 106.

In step 310, slide presentation program 104 receives specified slide hiding criteria and specified slide reordering criteria. Specified slide hiding criteria is utilized to specify how slide hiding module 108 should reduce slide times and/or hide slides in the slide deck, if necessary, to ensure that a total target presentation time is met. Specified slide hiding criteria can take any form, such as, for example, a single rule or criterion or any combination of rules and criteria, as specified and inputted by the presenter. For example, the presenter can specify that slides having a particular subject matter tag should be reduced first, followed by hiding them, if necessary; the presenter can specify that slides whose audience tags conflict with the specified audience should be hidden first, followed by the reduction of slides having a lowest priority value; or the presenter can specify that slides having a particular subject matter tag and lowest priority should be hidden first, followed by hiding slides having the particular subject matter tag and a second lowest priority, followed by hiding slides having another particular subject matter tag.

Slide reordering criteria is utilized to specify how slide reordering module 110 should reorder slides in the slide deck after slides have been reduced and/or hidden by slide hiding module 108. As with the specified slide hiding criteria, the specified slide reordering criteria can take any form, such as, for example, a single rule or criterion or any combination of rules and criteria, as specified and inputted by the presenter. For example, the presenter can specify that slides should be reordered such that slides having higher priority values are presented first; the presenter can specify that slides should be reordered such that slides having a particular subject matter tag or audience tag are presented first, followed by slides having another particular subject matter tag or audience tag; or the presenter can specify that slides should be reordered such that slides having the shortest presentation times and highest priority values are presented first.

If the presenter does not specify hiding and reordering criteria, slide presentation program 104 can assign default criteria such as, for example, hiding slides having lower priority values first, and reordering slides such that slides having higher priority values are presented first.

In step 312, slide presentation program 104 receives a total target presentation time (TTPT). For example, the presenter can specify a TTPT equal to the duration of time he or she has been allotted for the entire presentation, or equal to the duration of time he or she otherwise wishes to spend presenting the entire presentation.

In step 314, slide presentation program 104 calculates an estimated total presentation time (ETPT). In this exemplary embodiment, slide presentation program 104 calculates the ETPT by summing the specified ideal presentation times for each slide in the slide deck that is not marked with a “hide” designation. At step 314 of this embodiment, no slides are marked with a “hide” designation.

In step 316, slide presentation program 104 determines whether the TTPT is greater than or equal to the ETPT. If the TTPT is greater than or equal to the ETPT (i.e., the presenter can spend the specified ideal amount of time presenting each slide in the slide deck and still meet the TTPT), the slide deck is not adjusted.

If, in step 316, the TTPT is not greater than or equal to the ETPT (i.e., the presenter will not be able to spend the specified ideal amount of time presenting each slide in the slide deck and still meet the TTPT), then slide presentation program 104 calls slide hiding module 108. In step 318, pursuant to the specified slide hiding criteria received in step 310, slide hiding module 108 reduces the presentation times of one or more slides and/or hides one or more slides in the slide deck such that the TTPT is greater than or equal to the ETPT. Slide hiding module 108 then calls slide reordering module 110.

In step 320, pursuant to the specified slide reordering criteria received in step 310, slide reordering module 110 reorders the slides in the slide deck.

After step 316 or step 320 is performed, preparation of the slide deck is completed and is ready to be presented. However, at any time, the presenter can adjust the slide deck. For example, the presenter can modify the specified audience, TTPT, and slide hiding and reordering criteria; the presenter can manually adjust individual slide presentation times; and the presenter can add, remove, and hide slides.

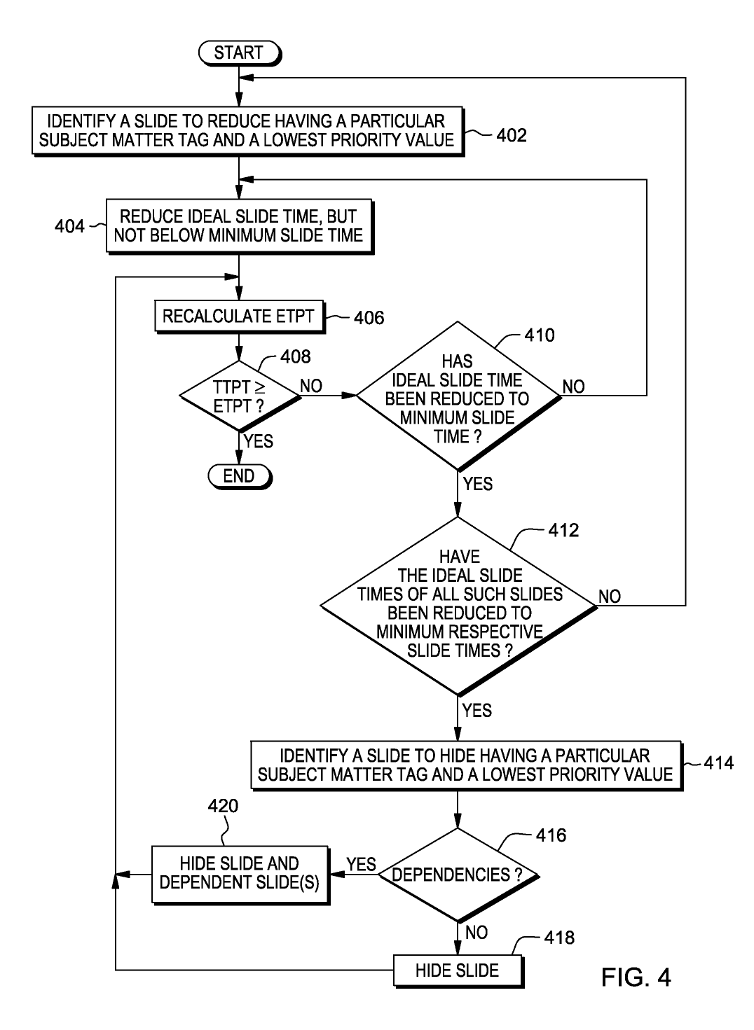

FIG. 4 is a flowchart illustrating operational steps for reducing the presentation times of one or more slides in a presentation and/or hiding one or more slides in a slide presentation in accordance with an embodiment of the present invention. For example, the operational steps illustrated in FIG. 4 can be performed at step 318 of FIG. 3. In this example, the specified hiding criteria provides that the slide presentation times of slides having a particular subject matter tag and the lowest priority value should first be reduced, one by one, but not below their respective minimum slide times. If after all such slides have been reduced to their respective minimum slide times and the target total presentation time for the slide deck is still not met, those slides are then hidden, one by one, until the target total presentation time is met.

In step 402, slide hiding module 108, pursuant to the specified hiding criteria, identifies a slide in the slide deck to reduce that has a particular subject matter tag (e.g., “business value”) and the lowest priority value among the slides having that particular subject matter tag.

In step 404, slide hiding module 108 reduces the ideal slide time for that slide, but not below the minimum slide time. For example, slide hiding module 108 can reduce the ideal slide presentation time in specified increments, such as 10-second increments. Slide hiding module 108 can also proportionately reduce the maximum slide time for the slide.

In step 406, slide hiding module 108 recalculates the ETPT. That is, slide hiding module 108 sums the reduced ideal slide time with the ideal slide times for the remainder of the slides in the slide deck.

In step 408, slide hiding module 108 determines whether the TTPT is now greater than or equal to the ETPT. If the TTPT is now greater than or equal to the ETPT, the operational steps illustrated in FIG. 4 end. If, in step 408, the TTPT is still not greater than or equal to the ETPT, then, in step 410, slide hiding module 108 determines whether the ideal slide time for the slide has been reduced to the minimum slide time for the slide.

If slide hiding module 108 determines that the ideal slide time for the slide has not been reduced to the minimum slide time for the slide, the operational steps of this exemplary embodiment repeat back at step 404, where the ideal time for the slide is further reduced. If slide hiding module 108 determines that the ideal slide time for the slide has been reduced to the minimum slide time for the slide, then, in step 412, slide hiding module 108 determines whether the ideal slide times for all other slides in the slide deck that have the particular subject matter tag have been reduced to their respective minimum slide times.

If, in step 412, slide hiding module 108 determines that the ideal slide times for these slides have not been reduced to their respective minimum slide times, then the operational steps repeat back at step 402, where slide hiding module 108 identifies another slide having the particular subject matter tag and the lowest priority value among the remaining slides having that particular subject matter tag. If, in step 412, slide hiding module 108 determines that the ideal slide times for each of these slides have been reduced to their respective minimum slide times, then, in step 414, slide hiding module identifies a slide to hide that has the particular subject matter tag and the lowest priority value among the slides having that particular subject matter tag (e.g., in this exemplary embodiment, the first slide identified to hide may be the slide that was first identified for reduction).

In step 416, slide hiding module 108 accesses one or more dependency maps 114 to determine whether the slide to be hidden is subject to any dependencies with other slides in the slide deck, as specified by the presenter during creation of the slide. If slide hiding module 108 determines that the slide is not subject to such dependencies, then, in step 418, slide hiding module 108 hides the slide by marking the slide with a “hide” designation. If, in step 416, slide hiding module 108 determines that the slide is subject to such dependencies, then, in step 420, slide hiding module 108 hides the slide and the one or more other slides on which the slide depends or which depend on the slide. For example, if the slide to be hidden is subject to a group-based dependency with two other slides in the slide deck (e.g., the two other slides would not make sense to the audience, in the view of the presenter, without the information the slide to be hidden would have provided), then slide hiding module 108 marks the slide and the two other slides with “hide” designations. A hidden slide remains viewable to the presenter, but will not be presented to the audience unless subsequently reintroduced. For example, hidden slides in the slide deck can be displayed to the presenter as being grayed-out, or with a strike-through.

After step 418 or step 420 is performed, the operational steps repeat back at step 406, where slide hiding module 108 recalculates the ETPT for the remaining slides in the slide deck (i.e., the slides that are not marked with “hide” designations). Accordingly, in this exemplary embodiment, one or more slides are reduced and, if necessary, hidden until the TTPT is greater than or equal to the ETPT.

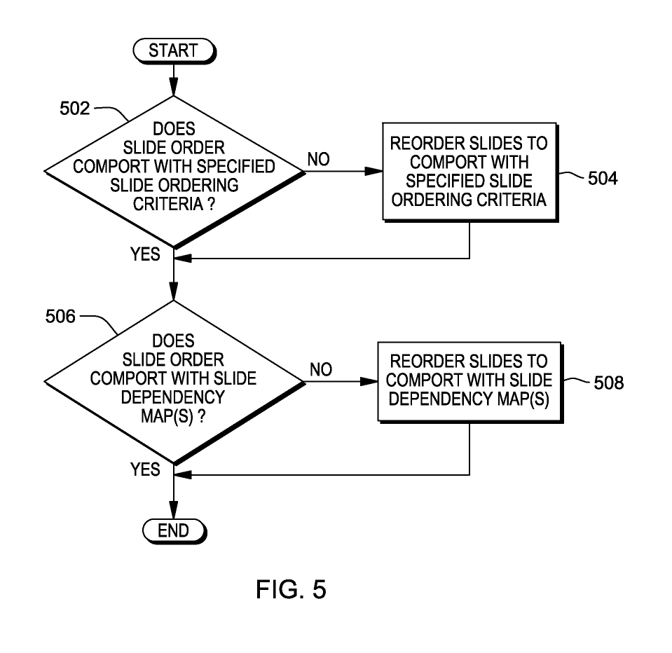

FIG. 5 is a flowchart illustrating operational steps for reordering slides in a slide presentation in accordance with an embodiment of the present invention. For example, the operational steps illustrated in FIG. 5 can be performed at step 320 of FIG. 3.

In step 502, slide reordering module 110 determines whether the current slide order of the slide deck comports with the specified slide ordering criteria, as specified by the presenter during creation of the slide presentation. For example, the specified slide ordering criteria can provide that the slide deck should be ordered such that slides having a particular subject matter tag should be presented first, while the remainder of the slide deck should be ordered based on priority values.

If, in step 502, slide reordering module 110 determines that the current slide order does not comport with the specified slide ordering criteria, then, in step 504, slide reordering module 110 reorders the slides to comport with the specified slide ordering criteria.

If slide reordering module 110 determines that the current slide order does comport with the specified slide ordering criteria, or, after step 504 is complete, then, in step 506, slide reordering module 110 determines whether the slide order comports with one or more dependency maps 114. For example, one or more of the slides may be subject to an order-based dependency (e.g., one or more slides must precede or be preceded by one or more other slides).

If, in step 506, slide reordering module 110 determines that the slide order does not comport with one or more dependency maps 114, then, in step 508, slide reordering module 110 reorders the slides to comport with one or more dependency maps 114.

If, in step 506 slide reordering module 110 determines that the slide order does comport with one or more dependency maps 114, or, after step 508 is complete, then the operational steps end.

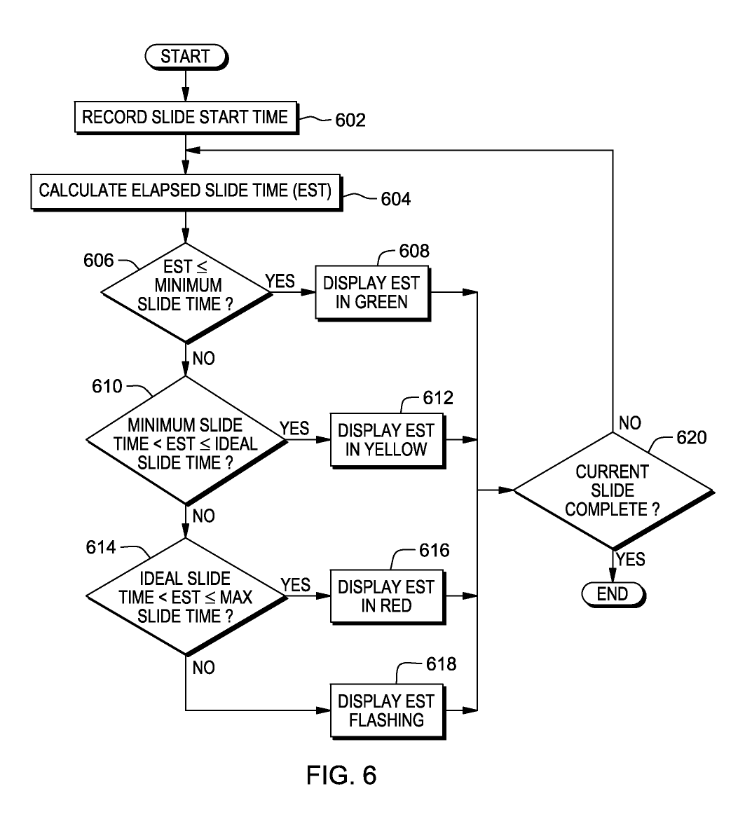

FIG. 6 is a flowchart illustrating operational steps for indicating an elapsed presentation time for a slide. In this exemplary embodiment, upon commencing a slide presentation with slide presentation program 104, slide presentation program 104 calls timer module 112. The operational steps illustrated in FIG. 6 are performed by timer module 112 for each slide that is presented to the audience.

In step 602, timer module 112 records the slide start time, which is the time at which the presenter begins presenting the slide to the audience. For example, timer module 112 can access and record the system time, as maintained by computer system 102, when slide presentation program 104 first outputs data to one or more presentation output devices 116 for delivery of the slide content to the audience.

In step 604, timer module 112 calculates the elapsed slide time (EST). The EST reflects the duration of time that has elapsed since the slide start time. Timer module 112 calculates the EST as the difference between the system time and the slide start time.

In step 606, timer module 112 determines whether the EST is less than or equal to the minimum slide time for the slide. If the EST is determined to be less than or equal to the minimum slide time, then, in step 608, timer module 112 instructs slide presentation program 104 to display to the presenter and/or audience the EST in numerical form using the color green.

If, in step 606, the EST is determined to be greater than the minimum slide time, then, in step 610, timer module 112 determines whether the EST is greater than the minimum slide time and less than or equal to the ideal slide time for the slide. If the EST is determined to be greater than the minimum slide time and less than or equal to the ideal slide time for the slide, then, in step 612, timer module 112 instructs slide presentation program 104 to display to the presenter and/or audience the EST in numerical form using the color yellow.

If, in step 610, the EST is determined to not be greater than the minimum slide time and less than or equal to the ideal slide time for the slide, then, in step 614, timer module 112 determines whether the EST is greater than the ideal slide time and less than or equal to the maximum slide time for the slide. If the EST is determined to be greater than the ideal slide time and less than or equal to the maximum slide time for the slide, then, in step 616, timer module 112 instructs slide presentation program 104 to display to the presenter and/or audience the EST in numerical form using the color red.

If, in step 614, the EST is determined to not be greater than the ideal slide time and less than or equal to the maximum slide time for the slide, then, in step 618, timer module 112 instructs slide presentation program 104 to display to the presenter and/or audience the EST flashing in numerical form.

After step 608, step 612, step 616, or step 618 is completed, in step 620, timer module 112 determines whether presentation of the current slide is complete. If it is determined that presentation of the current slide is complete, then the operational steps end. If it is determined that presentation of the current slide is not complete (i.e., the presenter is still presenting the slide to the audience), then the operational steps repeat back at step 604, where timer module 112 again calculates (i.e., updates) the EST.

Accordingly, in this exemplary embodiment, timer module 112 and slide presentation program 104 provide a visual indication to the presenter and/or audience of any discrepancies between the length of time the presenter has spent presenting the slide as compared to the minimum, ideal, and maximum slide times for the slide. This indication can enable the presenter and/or audience to quickly discern whether the presentation time for the slide is on schedule, or is running ahead of or behind schedule.

While this exemplary embodiment displays the EST in numerical form using a variety of colors, embodiments of the present invention can provide other visual and aural indications, such as, for example, displaying the EST in graphical form (e.g., a progress bar) and playing audio alerts for the presenter and/or audience.

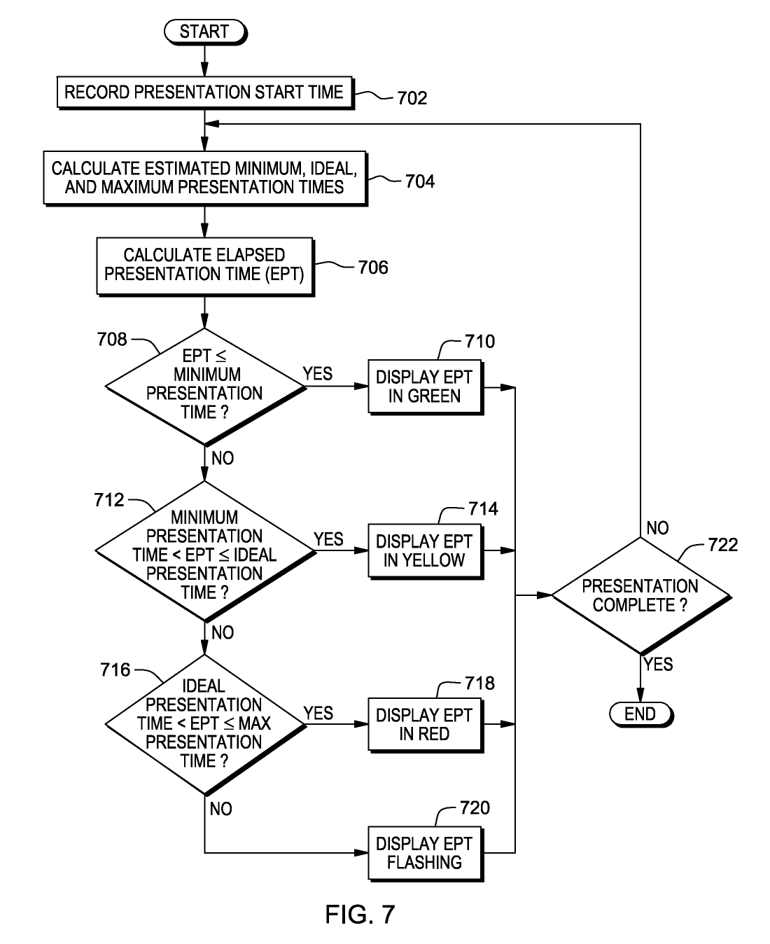

FIG. 7 is a flowchart illustrating operational steps for indicating an elapsed presentation time for a presentation. In this exemplary embodiment, upon commencing a slide presentation with slide presentation program 104, slide presentation program 104 calls timer module 112. The operational steps illustrated in FIG. 7 are performed by timer module 112 throughout the presentation of slides to the audience.

In step 702, timer module 112 records the presentation start time, which is the time at which the presenter beings presenting the first slide of the slide deck to the audience. For example, timer module 112 can access and record the system time when slide presentation program 104 first outputs data to one or more presentation output devices 116 for delivery of the first slide's content to the audience.

In step 704, timer module 112 calculates the estimated minimum, ideal, and maximum presentation times. Timer module 112 calculates the minimum presentation time by summing the minimum slide times for each of the slides in the slide deck; timer module 112 calculates the ideal presentation time by summing the ideal slide times for each of the slides in the slide deck; and timer module 112 calculates the maximum presentation time by summing the maximum slide times for each of the slides in the slide deck.

In step 706, timer module 112 calculates the elapsed presentation time (EPT). The EPT reflects the duration of time that has elapsed since the presentation start time. For example, timer module 112 can calculate the EPT as the difference between the system time and the presentation start time.

In step 708, timer module 112 determines whether the EPT is less than or equal to the estimated minimum presentation time. If the EPT is determined to be less than or equal to the estimated minimum presentation time, then, in step 710, timer module 112 instructs slide presentation program 104 to display to the presenter and/or audience the EPT in numerical form using the color green.

If, in step 708, the EPT is determined to be greater than the estimated minimum presentation time, then, in step 712, timer module 112 determines whether the EPT is greater than the estimated minimum presentation time and less than or equal to the estimated ideal presentation time. If the EPT is determined to be greater than the estimated minimum presentation time and less than or equal to the estimated ideal presentation time, then, in step 714, timer module 112 instructs slide presentation program 104 to display to the presenter and/or audience the EPT in numerical form using the color yellow.

If, in step 712, the EPT is determined to not be greater than the estimated minimum presentation time and less than or equal to the estimated ideal presentation time, then, in step 716, timer module 112 determines whether the EPT is greater than the estimated ideal presentation time and less than or equal to the estimated maximum presentation time. If the EPT is determined to be greater than the estimated ideal presentation time and less than or equal to the estimated maximum presentation time, then, in step 718, timer module 112 instructs slide presentation program 104 to display to the presenter and/or audience the EPT in numerical form using the color red.

If, in step 716, the EPT is determined to not be greater than the estimated ideal presentation time and less than or equal to the estimated maximum presentation time, then, in step 720, timer module 112 instructs slide presentation program 104 to display to the presenter and/or audience the EPT flashing in numerical form.

After step 710, step 714, step 718, or step 720 is completed, in step 722, timer module 112 determines whether the presentation is complete (e.g., all slides in the slide deck have been presented, or the presenter has terminated the presentation). If it is determined that presentation of the presentation is complete, then the operational steps end. If it is determined that presentation is not complete (i.e., the presenter is still presenting a slide to the audience), then the operational steps repeat back at step 704, where timer module 112 again calculates an estimated minimum, ideal, and maximum presentation time. In this embodiment, the operational steps repeat back at step 704 such that any modifications to the slide deck during the course of the presentation (e.g., reduction of slide times and/or hiding of slides), whether manually or automatically performed, are reflected in an updated calculation of the estimated minimum, ideal, and maximum presentation times.

Accordingly, in this exemplary embodiment, timer module 112 and slide presentation program 104 provide a visual indication to the presenter and/or audience of any discrepancies between the length of time the presenter has spent presenting the whole presentation as compared to the estimated minimum, ideal, and maximum presentation times. This indication can enable the presenter and/or audience to quickly discern whether the presentation time for the whole presentation is on schedule, or is running ahead of or behind schedule.

As with the EST, while this exemplary embodiment displays the EPT in numerical form using a variety of colors, embodiments of the present invention can provide other visual and aural indications, such as, for example, displaying the EPT in graphical form (e.g., a progress bar) and playing audio alerts for the presenter and/or audience. Further, embodiments of the present invention can simultaneously indicate both the EST and the EPT.

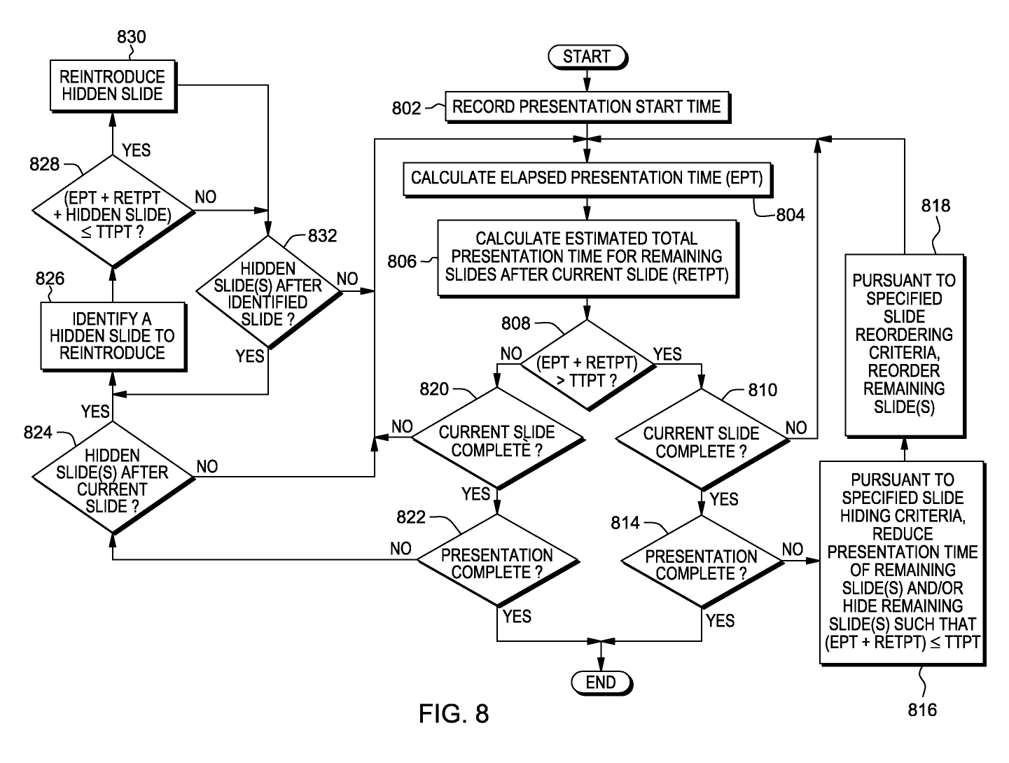

FIG. 8 is a flowchart illustrating operational steps for reducing the presentation time of one or more slides in a presentation and/or hiding one or more slides in accordance with an embodiment of the present invention. In this exemplary embodiment, upon commencing a slide presentation with slide presentation program 104, slide presentation program 104 calls timer module 112. The operational steps illustrated in FIG. 8 are performed throughout the presentation of slides to the audience, such that one or more slides can be automatically reduced and/or hidden to achieve a target presentation time. Further, one or more hidden slides can be automatically reintroduced to the extent that the target presentation time can still be achieved.

In step 802, timer module 112 records the presentation start time and, in step 804, timer module 112 calculates the elapsed presentation time (EPT), as previously discussed with regard to steps 702 and 704 of FIG. 7, respectively.

In step 806, timer module 112 calculates an estimated total presentation time for the remaining slides in the slide deck after the slide currently being presented (RETPT). In this exemplary embodiment, timer module 112 calculates the RETPT by summing the ideal presentation times for each of the remaining slides in the slide deck after the slide currently being presented that are not marked with “hide” designations.

In step 808, timer module 112 determines whether the sum of the EPT and the RETPT is greater than the TTPT. That is, timer module 112 determines whether, given the amount of time already spent presenting, the presenter will exceed the total target presentation time if he or she spends the specified ideal amount of time presenting each of the remaining slides in the slide deck that are not marked with “hide” designations.

If, in step 808, timer module 112 determines that the sum of the EPT and the RETPT is greater than the TTPT (i.e., at this time, the presenter will exceed the total target presentation time), then, in step 810, timer module 112 determines whether presentation of the current slide is complete. If, in step 810, timer module 112 determines that presentation of the current slide is not complete, then the operational steps repeat back at step 804, as previously discussed.

If, in step 810, timer module 112 determines that presentation of the current slide is complete, then, in step 814, timer module 112 determines whether the presentation is complete. If, in step 814, timer module 112 determines that the presentation is complete, then the operational steps end.

If, in step 814, timer module 112 determines that the presentation is not complete, then, in step 816, timer module 112 calls slide hiding module 108. In step 816, pursuant to specified slide hiding criteria provided during creation of the slide deck, slide hiding module 108 reduces the presentation times of one or more of the remaining slides and/or hides one or more of the remaining slides such that the sum of the EPT and the RETPT is less than or equal to the TTPT. Slide hiding module 108 then calls slide reordering module 110. For example, step 816 can be performed in accordance with the discussions of FIGS. 3 and FIG. 4. However, here, step 816 ensures that the sum of the EPT and the RETPT is less than or equal to the TTPT, as opposed to ensuring that the ETPT is less than or equal to the TTPT.

In step 818, slide reordering module 110 reorders the remaining slides in the slide deck pursuant to the specified slide reordering criteria provided during creation of the slide deck. For example, step 818 can be performed in accordance with the discussions of FIGS. 3 and 5. After step 818 is performed, the operational steps repeat back at step 804, as previously discussed.

If, in step 808, timer module 112 determines that the sum of the EPT and the RETPT is not greater than the TTPT (i.e., at this time, the presenter will not exceed the total target presentation time), then, in step 820, timer module 112 determines whether presentation of the current slide is complete. If, in step 820, timer module 112 determines that presentation of the current slide is not complete, then the operational steps repeat back at step 804, where timer module 112 again calculates (i.e., updates) the EPT.

If, in step 820, timer module 112 determines that presentation of the current slide is complete, then, in step 822, timer module 112 determines whether the presentation is complete. If, in step 822, timer module 112 determines that the presentation is complete, then the operational steps end. If, in step 822, timer module 112 determines that the presentation is not complete, then, in step 824, timer module 112 determines whether there are any hidden slides (i.e., slides marked with a “hide” designation) in the slide deck after the current slide.

If, in step 824, timer module 112 determines that there are no hidden slides in the slide deck after the current slide, then the operational steps repeat back at step 804, where timer module 112 again calculates (i.e., updates) the EPT. If, in step 824, timer module 112 determines that there are one or more hidden slides in the slide deck after the current slide, then, in step 826, timer module 112 identifies a hidden slide to reintroduce. In this exemplary embodiment, timer module 112 identifies a hidden slide that is after the current slide and has most recently been marked with a “hide” designation.

In step 828, timer module 112 determines whether the sum of the EPT, the RETPT, and the ideal presentation time of the identified hidden slide is less than or equal to the TTPT. That is, timer module 112 determines whether, if the identified hidden slide is reintroduced into the slide presentation, the sum of the EPT and the RETPT will remain less than or equal to the TTPT. If, in step 828, timer module 112 determines that the sum of the EPT, the RETPT, and the ideal presentation time of the identified hidden slide is less than or equal to the TTPT, then, in step 830, timer module 112 calls slide hiding module 108 and slide hiding module 108 reintroduces the identified hidden slide by removing its “hide” designation. The reintroduced slide will be presented during the slide presentation unless subsequently hidden.

After step 830 is completed or if, in step 828, timer module 112 determines that the sum of the EPT, the RETPT, and the ideal presentation time of the identified hidden slide is not less than or equal to the TTPT, timer module 112 determines, in step 832, whether there are one or more hidden slides after the slide previously identified in step 826. If, in step 832, timer module 112 determines that there are one or more hidden slides after the slide previously identified in step 826, then the operational steps repeat at step 826, where timer module 112 identifies another hidden slide to reintroduce, as previously discussed.

If, in step 832, timer module 112 determines that there are no hidden slides after the slide previously identified in step 826, then the operational steps repeat back at step 804, where timer module 112 again calculates (i.e., updates) the EPT.

Accordingly, this exemplary embodiment automatically reduces one or more remaining slides and/or hides one or more slides during the slide presentation such that the total target time can be achieved. Further, one or more hidden slides that are after the slide being presented can be reintroduced into the slide presentation if time permits. In this embodiment, the automatic adjustments are made to the remaining slides after presentation of the current slide is complete. However, at any time, the presenter can adjust the slide deck. For example, the presenter can modify the specified audience, TTPT, and slide hiding and reordering criteria; the presenter can manually adjust individual slide presentation times; and the presenter can add, remove, and hide slides.

The operational steps of FIGS. 2 through 8 are illustrative of one or more embodiments of the present invention. It should be understood that the content of each step, as well as the order of operation, can be modified without departing from the spirit and intended scope of the present invention.

FIG. 9 is a block diagram of internal and external components of computer system 102 in accordance with an embodiment of the present invention. It should be appreciated that FIG. 9 provides only an illustration of one implementation and does not imply any limitations with regard to the environments in which different embodiments may be implemented. Many modifications to the depicted environment may be made based on design and implementation requirements. Examples of computer systems, environments, and/or configurations that may be represented by FIG. 9 include, but are not limited to, desktop computers, laptop computers, server computers, thin clients, thick clients, multiprocessor systems, microprocessor-based systems, and distributed cloud computing environments that include any of the above systems or devices.

Computer system 102 includes one or more buses 902, which provide for communications between one or more processors 904, memory 906, persistent storage 908, communications unit 912, and one or more input/output (IO) interfaces 914.

Memory 906 and persistent storage 908 are examples of computer-readable tangible storage media. Computer-readable tangible storage media are capable of storing information such as data, program code in functional form, and/or other suitable information on a temporary basis and/or permanent basis. One or more operating systems, slide presentation program 104, slide data store 106, slide hiding module 108, slide reordering module 110, timer module 112, and one or more dependency maps 112 are stored in persistent storage 908 for execution and/or access by one or more of the respective processors 904 via one or more memories of memory 906.

Memory 906 can include one or more random access memories (RAM) 916, cache memory 918, or any other suitable volatile or non-volatile storage media. Persistent storage 908 can be a magnetic disk storage medium of an internal hard drive. Alternatively, persistent storage 908 can be a semiconductor storage medium such as ROM, EPROM, flash memory or any other computer-readable tangible storage medium that can store a computer program and digital information. The storage media used for persistent storage 908 can also be removable. For example, a removable hard drive can be used for persistent storage 908. Other examples include optical or magnetic disks, thumb drives, or smart cards that are inserted into a drive for transfer onto another storage medium that is also a part of persistent storage 908.

Communications unit 912 provides for communications with other computer systems and/or devices via network 118. The network may comprise, for example, copper wires, optical fibers, wireless transmission, routers, firewalls, switches, gateway computers, and/or edge servers. Communications unit 912 may include network adapters or interfaces such as TCP/IP adapter cards, wireless Wi-Fi interface cards, 3G or 4G wireless interface cards, or interfaces for other wired or wireless communications links. Software and data used to practice embodiments of the present invention can be downloaded from an external computer system via network 118 and communications unit 912 and can be loaded onto persistent storage 908.

One or more I/O interfaces 914 allow for input and output of data with other devices that may be connected to computer system 102. For example, I/O interfaces 914 can provide a connection to one or more external devices 920 and display 922. External devices 920 can include, for example, a keyboard, computer mouse, touch screen, and other human interface devices. External devices 920 can also include portable computer-readable tangible storage media such as, for example, thumb drives, portable optical or magnetic disks, and memory cards. Software and data used to practice embodiments of the present invention can be stored on such portable storage media and can be loaded onto persistent storage 908. External devices 920 can also include one or more presentation output devices 116.

Display 922 provides a mechanism to display data to a user and can be, for example, a computer monitor. Alternatively, display 922 can be an incorporated display that also functions as an input device, such as, for example, a display that also functions as a touch screen. Display 922 can also function as one or more presentation output devices 116.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “system.” Furthermore, aspects of the present invention may take the form of a computer program product embodied in one or more computer-readable tangible storage media having computer-readable program instructions embodied thereon.

It will be understood that each block of the flowchart illustrations and/or block diagrams, and combinations of blocks in the flowchart illustrations and/or block diagrams, can be implemented by computer instructions. These computer instructions may be provided to a processor of a computer system such as a general purpose computer, special purpose computer, or other programmable data processing apparatus to produce a machine, such that instructions, which execute via the processor of the computer system or other programmable data processing apparatus, create means for implementing the functions/acts specified in the flowchart and/or block diagram blocks.

The aforementioned programs can be written in any combination of one or more programming languages, including, for example, low-level, high-level, object-oriented or non object-oriented languages, such as Java®, Smalltalk, C, and C++. The program code may execute entirely on a user's computer system, partly on a user's computer system, as a stand-alone software package, partly on a user's computer system and partly on a remote computer system, or entirely on a remote computer system or server. In the latter scenario, the remote computer system may be connected to the user's computer system through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware.

The foregoing description of various embodiments of the present invention has been presented for purposes of illustration and description. It is not intended to be exhaustive nor limit the invention to the precise form disclosed. Many modifications and variations of the present invention are possible. Such modifications and variations that may be apparent to a person skilled in the art of the invention are intended to be included within the scope of the invention as defined by the accompanying claims.

What is claimed is:

1. A method for dynamically managing a slide presentation, the method comprising:
a computer system identifying a plurality of slides in a slide presentation, wherein each respective slide of the plurality of slides is associated with metadata, the metadata including a subject matter tag and a slide duration within which presentation of the respective slide should be completed;
the computer system receiving a specified presentation duration within which the slide presentation should be completed;
the computer system determining whether the slide presentation can be completed within the presentation duration;
responsive to determining that the slide presentation can not be completed within the presentation duration, the computer system adjusting the slide presentation based, at least in part, on the metadata associated with each slide, such that the slide presentation can be completed within the presentation duration; and
the computer system reordering one or more slides in the slide presentation based, at least in part, on the metadata associated with each slide.

2. The method of claim 1, wherein said adjusting the slide presentation comprises:
the computer system hiding one or more slides that are associated with a specified subject matter tag such that the hidden one or more slides are not presented and the slide presentation can be completed within the presentation duration.

3. The method of claim 1, wherein said adjusting the slide presentation comprises:
the computer system reducing the slide duration of one or more slides that are associated with a specified subject matter tag such that the slide presentation can be completed within the presentation duration.

4. The method of claim 1, wherein said adjusting the slide presentation comprises:
the computer system hiding one or more slides that are associated with a specified subject matter tag such that the hidden one or more slides are not presented, and the computer system reducing the slide duration of one or more slides that are associated with a specified subject matter tag, such that the slide presentation can be completed within the presentation duration.

5. The method of claim 1, wherein the metadata associated with each slide further includes an audience tag, and wherein said adjusting the slide presentation comprises:
the computer system hiding one or more slides that are associated with a specified audience tag such that the hidden one or more slides are not presented and the slide presentation can be completed within the presentation duration.

6. The method of claim 1, wherein the metadata associated with each slide further includes an audience tag, and wherein said adjusting the slide presentation comprises:
the computer system reducing the slide duration of one or more slides that are associated with a specified audience tag such that the slide presentation can be completed within the presentation duration.

7. The method of claim 1, wherein the metadata associated with each slide further includes an audience tag, and wherein said adjusting the slide presentation comprises:
the computer system hiding one or more slides that are associated with a specified audience tag such that the hidden one or more slides are not presented, and the computer system reducing the slide duration of one or more slides that are associated with a specified audience tag, such that the slide presentation can be completed within the presentation duration.

8. A computer system for dynamically managing a slide presentation, the computer system comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, the program instructions comprising:
program instructions to identify a plurality of slides in a slide presentation, wherein each respective slide of the plurality of slides is associated with metadata, the metadata including a subject matter tag and a slide duration within which presentation of the respective slide should be completed;
program instructions to identify a presentation duration within which the slide presentation should be completed;
program instructions to determine whether the slide presentation can be completed within the presentation duration;
program instructions to, responsive to determining that the slide presentation can not be completed within the presentation duration, adjust the slide presentation based, at least in part, on the metadata associated with each slide, such that the slide presentation can be completed within the presentation duration; and
program instructions to reorder one or more slides in the slide presentation based, at least in part, on the metadata associated with each slide.

9. The computer system of claim 8, wherein said program instructions to adjust the slide presentation comprise:
program instructions to hide one or more slides that are associated with a specified subject matter tag such that the hidden one or more slides are not presented and the slide presentation can be completed within the presentation duration.

10. The computer system of claim 8, wherein said program instructions to adjust the slide presentation comprise:
program instructions to reduce the slide duration of one or more slides that are associated with a specified subject matter tag such that the slide presentation can be completed within the presentation duration.

11. The computer system of claim 8, wherein said program instructions to adjust the slide presentation comprise:
program instructions to hide one or more slides that are associated with a specified subject matter tag such that the hidden one or more slides are not presented, and reduce the slide duration of one or more slides that are associated with a specified subject matter tag, such that the slide presentation can be completed within the presentation duration.

12. The computer system of claim 8, wherein the metadata associated with each slide further includes an audience tag, and wherein said program instructions to adjust the slide presentation comprise:
program instructions to hide one or more slides that are associated with a specified audience tag such that the hidden one or more slides are not presented and the slide presentation can be completed within the presentation duration.

13. The computer system of claim 8, wherein the metadata associated with each slide further includes an audience tag, and wherein said program instructions to adjust the slide presentation comprise:
program instructions to reduce the slide duration of one or more slides that are associated with a specified audience tag such that the slide presentation can be completed within the presentation duration.

14. A computer program product for dynamically managing a slide presentation, the computer program product comprising:
one or more computer-readable tangible storage media and program instructions stored on at least one of the one or more computer-readable tangible storage media, the program instructions comprising:
program instructions to identify a plurality of slides in a slide presentation, wherein each respective slide of the plurality of slides is associated with metadata, the metadata including a subject matter tag and a slide duration within which presentation of the respective slide should be completed;
program instructions to identify a presentation duration within which the slide presentation should be completed;
program instructions to determine whether the slide presentation can be completed within the presentation duration;
program instructions to, responsive to determining that the slide presentation can not be completed within the presentation duration, adjust the slide presentation based, at least in part, on the metadata associated with each slide, such that the slide presentation can be completed within the presentation duration; and
program instructions to reorder one or more slides in the slide presentation based, at least in part, on the metadata associated with each slide.

15. The computer program product of claim 14, wherein said program instructions to adjust the slide presentation comprise:
program instructions to hide one or more slides that are associated with a specified subject matter tag such that the hidden one or more slides are not presented and the slide presentation can be completed within the presentation duration.

16. The computer program product of claim 14, wherein said program instructions to adjust the slide presentation comprise:
program instructions to reduce the slide duration of one or more slides that are associated with a specified subject matter tag such that the slide presentation can be completed within the presentation duration.

17. The computer program product of claim 14, wherein said program instructions to adjust the slide presentation comprise:
program instructions to hide one or more slides that are associated with a specified subject matter tag such that the hidden one or more slides are not presented, and reduce the slide duration of one or more slides that are associated with a specified subject matter tag, such that the slide presentation can be completed within the presentation duration.

18. The computer program product of claim 14, wherein the metadata associated with each slide further includes an audience tag, and wherein said program instructions to adjust the slide presentation comprise:
program instructions to hide one or more slides that are associated with a specified audience tag such that the hidden one or more slides are not presented and the slide presentation can be completed within the presentation duration.

19. The computer program product of claim 14, wherein the metadata associated with each slide further includes an audience tag, and wherein said program instructions to adjust the slide presentation comprise:
program instructions to reduce the slide duration of one or more slides that are associated with a specified audience tag such that the slide presentation can be completed within the presentation duration.

20. The computer program product of claim 14, wherein the metadata associated with each slide further includes an audience tag, and wherein said program instructions to adjust the slide presentation comprise:
program instructions to hide one or more slides that are associated with a specified audience tag such that the hidden one or more slides are not presented, and reduce the slide duration of one or more slides that are associated with a specified audience tag, such that the slide presentation can be completed within the presentation duration.
